(19) United States
(12) Patent Application Publication
(10) Pub. No.: US 2006/0040015 A1
(43) Pub. Date: Feb. 23, 2006

(54) Method for reducing reactive protenatious compounds in red grape must

(75) Inventor: Karl Henry Wright, San Luis Obispo, CA (US)

Correspondence Address: LAW OFFICE OF PHILIP A STEINER, 846 HIGUERA STREET, SUITE 11, SAN LUIS OBISPO, CA, 93401, US

(73) Assignee: John Anthony Guido, Los Banos, CA (US)

(21) Appl. No.: 11/205,537

(22) Filed: Aug. 16, 2005

Related U.S. Application Data
(60) Provisional application No. 60/602,943, filed on Aug. 18, 2004.

(51) Int. Cl. C12G 1/00

(52) U.S. Cl. 426/15

(57) ABSTRACT

A method for reducing the affinity of proteinaceous compounds present in red grape must from binding with tannins, anthocyanins, polyphenolics and other organoleptic organic compounds. The method comprises thermally pre-treating red grape must to a temperature of between 45 to 65 degrees Celsius for approximately 5-20 minutes. Thereafter, cooling or allowing the treated red grape must to cool to ambient temperature for approximately 5-20 minutes. A package treatment system is provided which receives, thermally treats and returns the treated red grape must to either a vessel of origin or a normal downstream receiving vessel.

### CROSS-REFERENCE TO RELATED APPLICATIONS

This application is a non-provisional application claiming benefit and priority under 35 U.S.C. § 119(e) from U.S. provisional application Ser. No. 60/602,943 filed on Aug. 18, 2004 to the same inventor and assignee of record; said provisional application is herein incorporated by reference in its entirety.

### FEDERALLY SPONSORED RESEARCH AND DEVELOPMENT

Not Applicable.

### REFERENCE TO A MICROFICHE APPENDIX

Not Applicable.

### FIELD OF INVENTION

The present invention relates generally to a grape must processing method and more specifically to a method of processing red grape must to minimize protein binding affinity to desirable organic components in wines.

### BACKGROUND

Enology is an art that has been practiced for thousands of years. During the course of developing the different varieties of wines, it was noted that certain wines, in particular, white wines, tended to become cloudy when encountering elevated temperatures during poorly controlled shipping or storage conditions. White wine clouding was determined to be caused by protein suspensions forming in the wine. To alleviate the clouding in white wines, various processes are known in the art including; thermally pre-treating the white grape must after the grape skins have been removed, filtering the white wine product using benonite clays and/or contacting the white wine product with immobilized proteolytic enzymes. For simplicity and energy cost considerations, the use of benonite clays and immobilized proteolytic enzymes are practiced more frequently in the United States.

Protein clouding of red wines is not of significant concern since the polyvalent proteins become bound to tannins, anthocyanins, polyphenolics and other organic compounds during the fermentation process.

However, protein binding of the aforementioned compounds is believed to affect the organoleptic properties of red wines, which could potentially cause loss of color, body, or aroma thus impacting the taste of or final quality of the resulting wine product. Loss of color is of particular concern in the production of blush type wines for example, white zinfandels, pinot noirs and rośe wines.

To date, little attention has been given as to how protein binding impacts the quality of red wines, even though the binding of proteins to the polyphenolics is well known in the art. Instead, modern wineries still rely mainly on the skills of the winemaking artisan to adjust the final red wine product by controlling the fermentation process and/or blending the red wine with other red wines to arrive at a wine having desirable organoleptic qualities. Unlike, white wines, it is impractical to treat red wines with benonite clays or proteolytic enzymes during or after fermentation due to the high concentration of organic compounds which would either be removed or altered, thus affecting the final red wine product.

Treating red wines with proteolytic enzymes produces peptides which imparts a “green” flavor to the resulting wine. While, attempting to pre-treat red grape must with benonite clays is equally impractical due to difficulties in effectively mixing the benonite clays with the grape must.

Furthermore, heating of red wines during the fermentation process will not significantly reduce the impact of protein binding on the final red wine product since bindings between the proteins and the organoleptic organic compounds form rapidly at the beginning of the fermentation process. Adding heat during fermentation must be carefully controlled to avoid killing off the yeast thereby impacting fermentation. In the production of red wines, thermal treatment of red grape must is sometimes performed for softening of the grape skins. However, due to energy costs and the careful monitoring required to prevent the “cooking” of the grape must, thermal treatment for grape skin softening is rarely practiced at modern wineries.

Various treatment processes have been incorporated into wine making for example, U.S. Pat. No. 6,238,880 to Moine discloses a process for stabilizing proteins in white wines by enzymatic digestion of the invertase produced during the fermentation process.

U.S. Pat. No. 6,203,286 to Moll, et al., discloses a vinification process for making a low-alcohol wine by separating grape juices or musts into a high-sugar and a low-sugar fractions prior to fermentation and selectively blending grape juices or must with the low-sugar fraction to form a low-alcohol wine.

U.S. Pat. No. 4,814,189 to Laude-Bousquet discloses a vinification process and apparatus for controlling the rate of fermentation by placing a heating structure in a horizontal plane in the winemaking vat during the fermentation process.

U.S. Pat. No. 4,711,785 to Bruch, discloses another vinification process for controlling the rate of fermentation by selectively extracting a liquid phase from the fermentation vat, thermally treating the extract liquid and reintroducing the thermally treated liquid phase into the fermentation vat. The temperature of the liquid phase is measured at selected points in the vat.

The thermal exchange with the extracted liquid phase is controlled over a period of time as a function of the measured temperatures to create a desired temperature gradient of the liquid phase in the fermentation vat to produce a wine of desired quality.

U.S. Pat. No. 4,978,539 to Colin, et al., discloses a process of treating an extracted vegetal juice, adjusting the pH of the extract before sulfiting, clarifying the extract, and subjecting the extract to micro-filtration through a membrane. The micro-filtered extract is then fermented to produce new alcoholic drinks having very pleasant organoleptic properties.

None of the disclosures teach an aerobic pre-fermentation process for red grape must which reduces the concentration of reactive proteins and provides a more uniform red grape must product for introduction into the fermentation process.

Two notable treatises on modern winemaking include “Principles and Practices of Winemaking,” by R. Boulton, V. Singleton, L. Bisson, and R. Kunkee, by Aspen Publishers, Inc. 1998 (ISBN 0-8342-1270-6) and “The Technology of Wine Making,” Fourth Edition, by M. Amerine, H. Berg, R. Kunkee, C. Ough, V. Singleton and A. Webb, AVI Publishing Company, Inc., 1980 (ISBN 0-87055-333-X); wherein pages 533-536 of the latter and pages 68-74; 79-80; 341-347; 553-554 of the former are herein incorporated by reference.

### SUMMARY

The invention addresses the limitations described above and provides a process to reduce the affinity of reactive proteins prior to fermentation. The invention comprises an enological process which includes the steps of creating a red grape must in a first vessel, the first vessel being maintained in an aerobic state, uniformly heating the red grape must to a temperature in a range of 45 to 65 degrees centigrade, maintaining this temperature range for a time in a range of 5 to 20 minutes and thereafter, cooling the red grape must to approximately ambient temperature in a short period of time, generally within 5 to 20 minutes. The temperature uniformity of the red grape must is generally accomplished by mixing the red grape must with an agitator.

The red grape must may be treated by recirculating the grape must back to the crushing vessel, recirculating the red grape must within the thermal treatment unit itself or transferring the treated red grape must to a fermentation vessel in a one pass operation.

The heating and cooling are generally accomplished by a heat exchanger in communication with the red grape must. In another aspect of the invention, cooling is performed by conductive and convective losses alone. The thermally treated red grape must may be transferred to a second vessel, such as a maceration vessel, a press vessel, a crusher vessel or a fermentation vessel following completion of the thermal treatment process.

In an another aspect of the invention, the enological process comprises, in a first vessel maintained in generally an aerobic state, thermally pre-treating a quantity of red grape must sufficiently to denature at least a portion of proteinaceous compounds present in the red grape must transferred from the first vessel, cooling the red grape must to approximately an ambient temperature within about 20 minutes, and thereafter, transferring the red grape must to a second vessel.

The thermally pre-treating consists essentially of heating the red grape must to a temperature range of 45 to 65 degrees centigrade for at least 5 minutes. The pre-treating includes mixing of the red grape must for uniformly heating a substantial portion of the red grape must. The second vessel may consist of a maceration vessel, a press vessel or a fermentation vessel.

### BRIEF DESCRIPTION OF DRAWINGS

FIG. 1—This drawing depicts the major steps for implementing a first embodiment of the invention.

FIG. 2—This drawing depicts the major steps for implementing a second embodiment of the invention.

### DETAILED DESCRIPTION

Wine making involves complex chemical and biochemical reactions to produce a quality wine having the proper color, body, bouquet and taste. Given the variability in grape products, due to climate differences, changes in soil nutrients, place and time of harvesting, mixing of varieties, much of this is accomplished through the skill of a master wine maker who can determine from the organoleptic properties of the maturing grapes what changes may be necessary to obtain a quality wine product. However, as the demand for quality wines has grown dramatically over the past quarter century, modernized methods of producing quality wines are now being investigated.

Proteins are polyvalent organic compounds comprised of various amino acids that bind with other organic compounds, particularly under the acidic conditions present during fermentation.

The protein structure or conformation influences the ability of the proteins found in grape musts and juices to bind with other organic compounds, which affect the aesthetic qualities of the resulting wine product. The majority of these proteins are heat liable at relatively low temperatures, allowing for thermal pretreatment. The thermal pretreatment process is controlled to provide sufficient energy to change the conformation of the proteins in the grape must stage but not at a rate or temperature that would cause “cooking” of the grape must. As such, by reducing the protein's affinity for the polyphenolic compounds present in red grape must, the organoleptic qualities of the unbound polyphenolics are present in greater concentrations in the resulting wine product.

An excellent treatise on protein denaturation is provided in “Protein Purification, Principle and Practice,” Third Edition by R. Scopes, 1994, Springer-Verlag, Inc. (ISBN 3-540-94072-3); wherein pages 96-101 are herein incorporated by reference.

The invention introduces an inline thermal treatment unit into the normal grape must processing stream. In an embodiment of the invention, the thermal treatment unit is placed at the outlet of a grape must processing unit and recirculates the treated grape must back to the grape must processing unit.

The thermal treatment unit incorporates a heat exchanger for heating and cooling of the grape must. A single heat exchanger can be used for both portions of the treatment cycle but separate heat exchangers for heating and cooling of the grape must may be incorporated as well. A slurry pump is used to recirculate the grape must between the existing grape must processing unit, normally a crushing unit, and the thermal treatment unit. The recirculation is operated at ambient to low pressure and maintained in an aerobic state to prevent premature fermentation and inhibit anaerobic bacterial growth. To the extent possible, the thermal treatment unit is intended to utilize existing infrastructures, piping and/or hose connections, heat exchanger fluids and electrical power commonly available at wineries to simplify the thermal treatment process.

The heating cycle raises the temperature of the grape must from ambient temperatures to a temperature in the range of 45-65 degrees centigrade. This temperature range provides the most effective protein denaturation without unduly damaging the red grape must product.

The elevated temperature is maintained for approximately 5 to 20 minutes to allow for uniform heating of the majority of the grape must volume. The heating portion of the treatment cycle is controlled to avoid overheating or “cooking” of the grape must.

The intent is expose the natural grape proteins present in the must to a temperature which causes a thermally induced confirmation change which has less binding potential to the tannins, anthocyanins and related polyphenolics present in the grape must and juice. After the heating cycle is completed, a cooling cycle reduces the temperature of the grape must from the elevated treatment temperature to approximately ambient temperature for approximately of 5-20 minutes. The accelerated cooling limits the growth of aerobic bacteria and heat damage to the grape must product.

An agitator, auger or commutator which is either part of the grape must processing unit or incorporated into the thermal treatment unit should be operated periodically during both the heating and cooling cycles to ensure uniform temperatures are reached throughout the grape must product.

A thermal screw is a common apparatus used in commercial food processing which may be used to perform the heating and cooling of the grape must slurry.

However, one skilled in the art will appreciate that there are many ways to perform the thermal treatment process and the invention is not limited to a thermal screw alone. The source of heating may be steam, glycol or preferably hot or cold water running through the shell side of a heat exchanger. All of which are generally available at larger scale wine production facilities. Standardized pipefitting and flexible hoses are intended to couple the thermal treatment unit to the grape must processing unit. Once the thermal treatment cycle has been completed, the treated grape must and juice product may then be fed into the normal downstream processing units, typically a maceration vessel, a grape press, a crusher or a fermentation vessel.

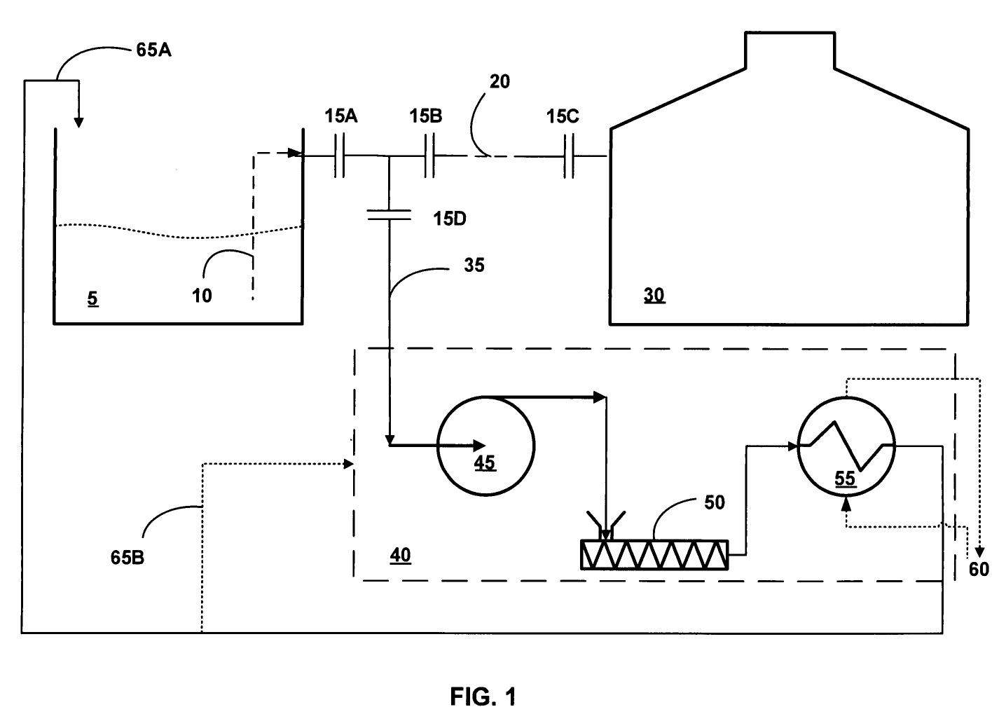

A simplified diagram of a first embodiment of the invention is shown in FIG. 1. In this first embodiment of the invention, an existing source tank 5, generally a crushing unit, containing the red grape must is coupled to an existing downstream tank 30, usually a fermentation vessel, by a removable spool piece 20 or hose.

The spool piece 20 is uncoupled from the simple junctions or fittings 15A, 15B, 15C, 15D in the normal piping or hose arrangements and attached to a package thermal treatment unit 40.

The red grape must is drawn 10 from the existing source tank 5 and transferred 35 by slurry pump 45 into a conveyor system 50. The slurry pump 45 may be of either a centrifugal or reciprocating type design. The conveyor system 50 may be a screw type integrated with a heat exchanger 55, (i.e., thermal screw,) or alternately, a separate conveyor system 50 and heat exchanger 55 arrangement will work as well. The slurry pump 45, conveyor system 50 and heat exchanger 55 are incorporated into the thermal treatment package unit 40 that allows for simple transportation and direct connection to existing winery process streams.

The thermal transfer fluid 60 used by the heat exchanger 55 is preferably water-based (hot and/or cold water) but may include steam or glycol based fluids. In another aspect of the invention, the heat exchanger 55 may also be electrically powered.

In a first embodiment of the invention, the thermally treated red grape must is recirculated by the slurry pump 45 through the heat exchanger 55 and returned 65A to the existing source tank 5. In alternate embodiment of the invention, the thermally treated red grape must may be recirculated 65B within the thermal treatment unit 40 itself until the desired temperature range and thermal treatment has been achieved.

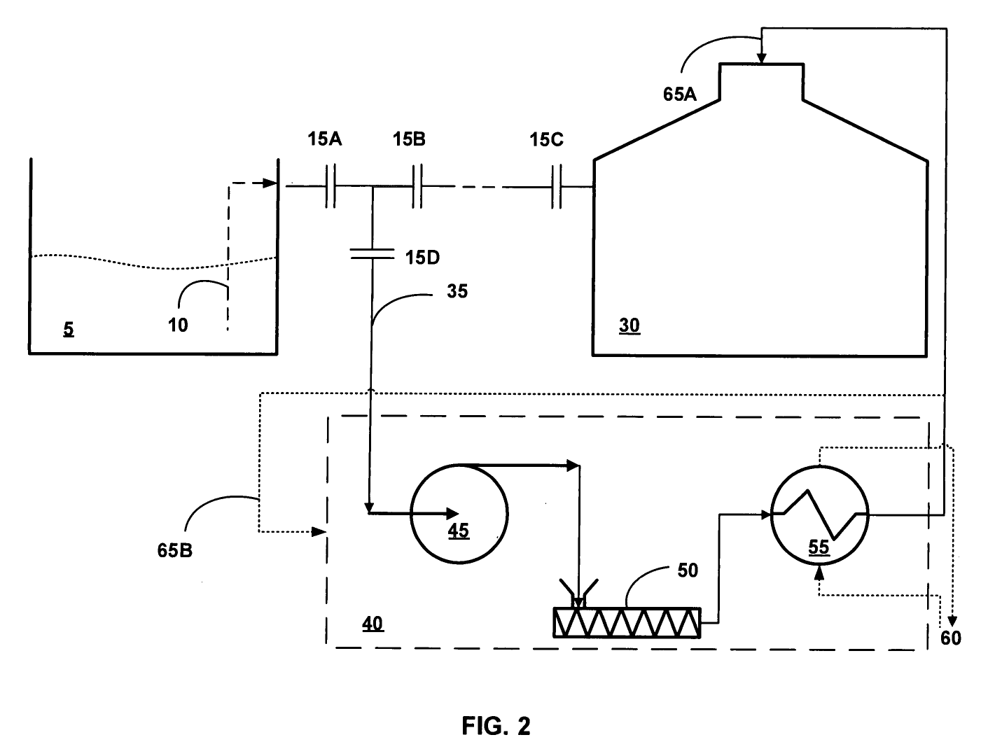

Referring to FIG. 2, the red grape must is drawn 10 from the existing source tank 5 as before, and transferred 35 by the slurry pump 45 into the conveyor system 50. However, in this second embodiment of the invention, the thermally treated red grape must is not recirculated to the source tank 5. Instead, the treated red grape must is processed by the thermal treatment unit 40 and discharged 65A directly into the downstream tank 30, usually a fermentation vessel. Alternately, or in combination therewith, the thermally treated red grape must may be recirculated 65B within the thermal treatment unit 40 itself until the desired temperature range and thermal treatment has been achieved as before.

In both embodiments of the invention, the slurry pump 45 and heat exchanger should be sized to raise the red grape must from ambient temperature to approximately 45 to 60 degrees Celsius in about 10-20 minutes. In the first embodiment (FIG. 1) the treatment the package unit 40 may be reduced somewhat to allow for the heat transfer occurring in the existing source tank 5.

Cooling of the thermally treated red grape must may be accomplished by forced cooling through the heat exchanger 55 or by allowing the treated must to cool to ambient temperatures on its own when transferred to either the existing 5 source tank or existing downstream tank 30. The thermal treatment may also be used to help induce and/or accelerate the fermentation of the red grape must by allowing cooling to a temperature above ambient, and/or accelerate the extraction of the polyphenolics from the red grape must.

The foregoing described embodiments of the invention are provided as illustrations and descriptions. They are not intended to limit the invention to precise form described. In particular, it is contemplated that functional implementation of the invention described herein may be implemented using different thermal treatment and transfer mechanisms than those described. Other variations and embodiments are possible in light of above teachings, and it is not intended that this Detailed Description limit the scope of invention, but rather by the Claims following herein.

I claim:

1. An aerobic enological process comprising:
producing a red grape must,
generally heating uniformly said red grape must to a temperature in a range of about 45 to 65 degrees centigrade,
maintaining said temperature range for a time in a range of about 5 to 20 minutes and thereafter,
cooling said red grape must to approximately ambient temperature in about 20 minutes.

2. The process according to claim 1 wherein at least a portion of said generally uniformly heating is accomplished by mixing said red grape must with an agitator.

3. The process according to claim 1 wherein at least a portion of said generally uniformly heating is accomplished by a heat exchanger in communication with said red grape must.

4. The process of claim 1 further comprising after said red grape must has reached at least said ambient temperature, transferring said red grape must to a process vessel.

5. The process according to claim 4 wherein said process vessel is one of a maceration vessel, a press vessel, a crusher vessel and a fermentation vessel.

6. An aerobic enological process comprising:
thermally pre-treating a quantity of red grape must by maintaining a temperature range of about 45-65 degrees Celsius,
cooling said red grape must to approximately an ambient temperature within 20 minutes and thereafter,
transferring said red grape must to a process vessel.

7. The process according to claim 6 wherein said process vessel is one of a maceration vessel, a press vessel, a crusher vessel and a fermentation vessel.

8. The process according to claim 6 wherein said pre-treating includes mixing of said red grape must for uniformly heating a substantial portion of said red grape must.

9. An aerobic enological process comprising:
transferring from a first vessel a quantity of red grape must,
routing said quantity of red grape must through a heat exchanger,
heating said quantity of red grape must in a range of about 45-65 degrees Celsius for about 5-20 minutes, and,
transferring said red grape must to one of a maceration vessel, a press vessel, a crusher vessel and a fermentation vessel.

10. The process according to claim 9 further including pre-cooling said red grape must before said transferring.

11. The process according to claim 10 wherein said pre-cooling is to approximately ambient temperatures.

12. The process according to claim 10 wherein said pre-cooling remains above ambient temperatures.

13. The process according to claim 9 wherein said heating is accomplished at least in part by recirculating at least a portion of said red grape must through said first vessel.

14. The process according to claim 9 wherein said heating is accomplished at least in part by recirculating at least a portion of said red grape must through said heat exchanger.

15. The process according to claim 9 wherein said heating is accomplished at least in part by a once through pass through said heat exchanger.

16. The process according to claim 9 wherein said first vessel is one of a maceration vessel, a press vessel and a crusher vessel.
